(19) United States
(12) Patent Application Publication
(10) Pub. No.: US 2014/0065327 A1
(43) Pub. Date: Mar. 6, 2014

(54) METHOD AND DEVICE FOR STRETCHING A MEMBRANE AND METHOD FOR PRODUCING A MULTI-PANE ELEMENT

(71) Applicants: Markus Kramer, Koblenz (DE); Klaus Kallee, Landsberg (DE); Heinz Schicht, Bethau (DE); Kurt Russell, Sint-Genesius-Rode (BE)

(72) Inventors: Markus Kramer, Koblenz (DE); Klaus Kallee, Landsberg (DE); Heinz Schicht, Bethau (DE); Kurt Russell, Sint-Genesius-Rode (BE)

(73) Assignee: Southwall Technologies Inc., Palo Alto, CA (US)

(21) Appl. No.: 13/985,173

(22) PCT Filed: Feb. 18, 2011
(86) PCT No.: PCT/EP2011/052445

§ 371 Date: Oct. 30, 2013

(51) Int. Cl. E06B 3/677; E06B 3/67

(52) U.S. Cl. CPC E06B 3/6775; E06B 3/67
USPC 428/34; 156/494; 156/109

(57) ABSTRACT

The invention relates in particular to a method for stretching a membrane (4), arranged between two panes (2, 3), of an insulating glazing unit (1). For effective stretching, it is proposed that the membrane (4) is exposed to a conditioning medium passed through an interspace (6, 7) between the panes (2, 3) and the membrane (4).

The invention relates to a method and to a device for stretching a membrane arranged between two panes and to a method for producing a multi-pane element.

In the case of insulation glass panes or insulation glass windows, in particular, it is known to provide a film or membrane, instead of a third glass pane, arranged with spacing between two glass panes.

In a device known from DE 27 53 127, and in a corresponding method for stretching such a film, said film is stretched mechanically, for example, by a specially designed frame. However, it can happen, that, after the stretching, the film has an undesired residual waviness, and is thus stretched only insufficiently.

Furthermore, in the case of heat shrinkable films, it is known to use exposure to radiation heat for the stretching. However, such a procedure is relatively time- and energy-consuming.

Based on this, a problem of the invention is to indicate a method and a device, by means of which films or membranes arranged with spacing between two panes can be stretched effectively, in particular relatively rapidly, and in an energy efficient manner.

Furthermore, from a similar standpoint, a manufacturing method for a multi-pane element is indicated.

This problem is solved by the characteristics of claims 1, 11 and 13. Variants of the invention can be obtained in the dependent claims.

According to claim 1, a method for stretching at least one membrane arranged between two panes is provided. Here, the term stretching is considered equivalent to the terms smoothing or tensioning and possibly shrinking.

The panes can be in particular glass panes, although other panes, made of transparent plastic, for example, that are used as a glass substitute, can also be considered. Suitable glass substitutes are, for example, materials such as acrylic glass, plastics, and other substitute materials. In general, the method, as well as the device described below and the manufacturing method are also usable in the case of membranes arranged between two plates, or in the case of a multi-pane element having at least one membrane located between two layers. A multi-pane element is, in particular, a multi-layer element. Multi-pane elements according to the invention can comprise two, three or more panes, wherein at least one membrane is provided in at least one interspace formed between two adjacent panes. A similar statement applies to multi-layer elements.

Without limiting the generality, the term membrane comprises in particular all types of films, in particular metal or plastic films. It is preferable for the membranes to be transparent, particularly for use in insulation glass panes, or insulation windows or doors. The membrane can be in particular a shrinkable membrane, in particular a shrink film, which can be shrunken by exposure to heat. Furthermore, the membrane can be an uncoated membrane, or a membrane, in particular a film, coated at least partially on one side or on both sides.

According to the method proposed here, for stretching, the at least one membrane is exposed to a conditioning medium which is passed through an interspace between one of the panes, on the one hand, and the membrane, on the other hand, and/or between two adjacent membranes.

The conditioning medium can be substantially any desired substance, in particular a liquid substance, but preferably a gaseous substance, which, in an appropriately conditioned state, at the time of exposure of the membrane, particularly at the time of contacting the membrane, produces the stretching thereof. A conditioning can occur in particular by heating the conditioning medium. In order to condition the conditioning medium, an additional additive can also be added to said medium, additive which at least promotes stretching, or produces other effects on the membrane. As conditioning medium, one can use, in particular, a desired filling medium for the at least one interspace, for example, a type of protective gas or inert gas, which remains in the interspaces or is enclosed therein, as filling, after the stretching of the membrane.

The following media are particularly suitable as conditioning medium: air, particularly ambient air, inert gas, protective gas, and others. Here, it is possible to use any desired mixtures of the above media. As inert gas one can consider in particular gasses such as krypton, xenon, argon, helium, and neon. As protective gases, one can use in particular any desired gases or gas mixtures that have the properties of displacing or absorbing atmospheric air or other undesired gases or substances. The use of inert or protective gases in the conditioning medium is particularly advantageous if the interspace is to be filled with an inert or protective gas in any case. The inert or protective gas, or in general the respective filling medium, can be used as a conditioning medium, or it can be added to said conditioning medium, during the entire stretching or at least in the end phase of the stretching, or in a cooling step downstream of the stretching. After the stretching or the cooling of the membrane, the interspace is then already filled with the respective filling medium. The interspaces can then be sealed from the environment with inclusion of the filling medium, so that a separate filling step for the inert or protective gas can be omitted.

Inert or protective gases or other media, in particular similar media, can be used, for example, in the case of insulation glass panes, in order to improve the insulation effect. If such media are already used in connection with the stretching of the membrane, then the manufacture of the insulation glass pane can be simplified. In particular, the number of manufacturing steps can be reduced, since separate filling steps for filling the interspace with the respective filling medium can be omitted.

Furthermore, it is possible to add to the conditioning medium a coating material that is suitable for coating the pane or the panes and/or the membrane. This can be advantageous particularly if the pane/s and/or membrane/s are not yet coated or if they are to be provided with an additional coating. For this purpose, at least one corresponding metering device with a container for the coating material can be provided, by means of which the coating material can be added by metering to the conditioning medium, at an appropriate point, for example, after the exit from the overpressure container. The mentioned coating materials can be used, for example, for the targeted modification of the transmission properties of the panes, or of the membrane or membranes. For example, a pane/panes and/or a membrane/membranes can be provided with an ultraviolet radiation- and/or infrared radiation-inhibiting coating. It is also possible to use coatings for antireflection, for tinting, etc. Particularly suitable for the coating are metals, such as aluminum, chromium, nickel, and copper. The coating material can also comprise paint particles for dyeing the membrane/s and/or pane/s. The coating material can be selected or composed in such a manner that a specific or at least a largely specific coating of one or more sides of the pane/s and/or of one or more sides of the membrane/s can occur.

The above-mentioned metering device can also be used for the addition by metering of the inert or protective gas to the conditioning medium. If required or appropriate, it is possible to use or to provide a separate metering device for the inert and/or protective gas.

The stretching can occur by different processes, particularly by chemical and/or physical processes. For example, the stretching of a thermally isotropic or anisotropic shrinkable membrane can occur by exposure to a corresponding heated conditioning medium, in particular a conditioning gas. If, in the case of the membrane, a stretching or shrinking can occur by the particular contribution of drying processes, it is possible to use a corresponding dried conditioning medium. In the case of membranes that can be stretched by several chemical and/or physical processes, particularly to a varying extent, it is possible to use an appropriately processed conditioning medium, so that several chemical and/or physical stretching processes can be generated simultaneously.

Since the conditioning medium which is passed through the interspace can interact directly with the at least one membrane, it is possible to achieve a particularly effective stretching. The deficiencies of the mechanical stretching and of the stretching due to the exposure to heat radiation in the state of the art can here be prevented. However, this should not exclude that an additional stretching of the membrane by mechanical tensioning can occur, in addition to the use of the conditioning medium. Likewise, it is not ruled out that, in the case of heat stretchable membranes, an additional stretching due to the action of heat radiation can occur.

The passage of the conditioning medium through an interspace implies that a respective membrane is spaced from at least one of the panes or from an additional membrane. Here, the panes and the at least one membrane can be arranged parallel to each other, in particular plane parallel. Furthermore, it is possible for the panes and the at least one membrane to extend at least partially along a curve while preserving a constant mutual spacing. The interspace can be one or more free spaces formed between a pane and an adjacent membrane, or between adjacent membranes. In particular, it is thus possible for the conditioning medium to be passed through all the free spaces formed between panes and membrane or membranes, or between membranes, or for the conditioning medium to be passed selectively through one or more selected free spaces. An effective stretching can be achieved particularly if the conditioning medium is passed through free spaces located on both sides of the at least one membrane. In the last case, the area available for the interaction between conditioning medium and membrane, and thus the stretching of the membrane, can be maximized.

As a result of the construction, the panes and the at least one membrane located in between is held by a frame that runs at least partially around the edges of the panes. In this case, it is possible for the conditioning medium to be passed through cuts or openings of the frame, in particular via the cuts or openings of the frame, to the interspaces, or to be removed from them. Here it is possible for the cuts and optionally the frame to be provided and formed in such a manner that the conditioning medium can be passed in direct current mode or in countercurrent mode through the interspaces.

With a view to a particularly effective stretching, it can be particularly advantageous if the conditioning medium is supplied to the at least one interspace and/or removed therefrom, via at least one lance which is inserted or insertable into at least one interspace, preferably via at least one dual or multiple lance. With the lance inserted, the conditioning medium can be delivered particularly advantageously directly in the respective interspace.

Depending on the constitution and the stretching properties of the membrane, for stretching the membrane, the conditioning medium can be heated and/or dried. In general, the conditioning medium can be prepared or conditioned in such a manner that the membrane achieves a desired or predetermined stretching, particularly in the shortest possible time. Naturally, other specifications in connection with stretching are also possible. Heating and drying are considered particularly in the case of membranes that can be stretched thermally. For stretching, particularly thermal stretching, of the membrane, stretching temperatures of up to 80° C. or up to 90° C. or between 100° C. and 105° C. or higher can be used.

Furthermore, before exposure of the membrane, the conditioning medium can be subjected to a cleaning step. For this purpose, foreign substances can be removed from the conditioning medium. Gaseous conditioning media, in particular, can be dried and/or filtered, for example, for this purpose. The drying can occur by removing water by condensation. For this purpose one can use, for example, an absorption chiller or a compression chiller. However, drying, optionally with the addition of a hygroscopic material, is also possible.

By drying and/or filtering of the conditioning medium, one can in particular prevent substances that can potentially lead to degradation from depositing or accumulating in the interspace or in the free spaces. For example, by means of a thorough drying, it is possible to prevent the collection of moisture in the interspace, or moisture can be removed. In the case of a completed insulation glass pane, moisture can lead, for example, to turbidity, which as a rule requires replacement of the insulation glass pane.

As suitable conditioning medium, one can use the following media, in particular: air, in particular ambient air, inert gas, protective gas, and others. Here, it is possible to use any desired mixtures of the above media. As inert gas one can consider in particular gasses such as krypton, xenon, argon, helium, and neon. As protective gases, one can use in particular any desired gases or gas mixtures that have the properties of displacing or absorbing atmospheric air or other undesired gases or substances. The use of inert or protective gases already at the time of the stretching of the membrane is particularly advantageous if the interspace is to be filled with an inert or protective gas in any case. The inert or protective gas, or in general the respective filling medium, can be used as a conditioning medium during the entire stretching or at least in the end phase of the stretching. After the stretching of the membrane, the interspace is then already filled with the respective filling medium. The interspaces can then be sealed from the environment with inclusion of the filling medium, so that a separate filling step for the inert or protective gas can be omitted.

Inert or protective gases or other, particularly similar, media can be used, for example, in the case of insulation glass panes, in order to improve the insulation effect. If such media are already used at the time of the stretching of the membrane, the manufacture of the insulation glass pane can be simplified. In particular, the number of manufacturing steps can be reduced, since the separate filling of the interspace with the respective filling medium can be omitted.

A further simplification of the manufacture can be achieved if a coating material suitable for coating the pane or the panes and/or the membrane is added to the conditioning medium. Such coating materials can be used, for example, for the targeted modification of the transmission properties of the panes or of the membrane or of the membranes. For example, a pane/panes and/or a membrane/membranes can be provided with an ultraviolet radiation- and/or infrared radiation-inhibiting coating. Antireflective coatings for tinting, etc., are also possible. Particularly suitable for the coating are metals, such as aluminum, chromium, nickel, and copper. The coating material can also comprise paint particles for dyeing the membrane/s and/or pane/s. The coating material can be selected or composed in such a manner that a specific or at least a largely specific coating of one or more sides of the pane/s and/or of one or more sides of the membrane/s can occur.

In particular, if the conditioning medium is a special inert or protective gas, it can be advantageous, taking also into consideration the question of cost, if the conditioning medium is reused. For this purpose, after leaving the interspace, the conditioning medium can be collected and optionally purified and processed, in particular filtered, dried, etc. Such a procedure can also be appropriate if the conditioning medium is recycled during the tensioning of the membrane. Here it is possible to process the conditioning medium continuously. After processing, the conditioning medium can be used again for stretching the membrane. However, it is also possible to transfer the conditioning medium after processing into a storage tank or an intermediate storage tank, from which it can be retrieved as needed. If no reuse is planned, the conditioning medium can be released into the environment, which naturally should occur only with conditioning media that have no detrimental effects on the environment.

In particular, if the at least one membrane is thermally stretched, a cooling medium can be led through at least one interspace adjoining the membrane, for cooling the at least one membrane after it has been exposed to heated conditioning medium. The temperature of the cooling medium is preferably regulated accordingly, and the cooling medium is preferably adjusted by drying to a predetermined maximum humidity. The cooling medium can be gaseous and it can comprise in particular air, ambient air and/or gaseous conditioning medium.

By means of the cooling medium that is led through the at least one interspace between membrane and pane(s), or between two membranes, the membrane(s), in particular, can be cooled to a desired final temperature, usually ambient temperature. It is preferable for the cooling medium to be adjusted, prior to the introduction into the interspace, to a corresponding low cooling temperature, wherein a stepwise or continuous reduction of the cooling temperature in a cooling temperature curve for a flatter temperature gradient is also possible. The cooling temperature of the cooling medium, before introduction into the interspace, can be situated or varied in particular between 4° C. and the stretching temperature, for example, 90° C., or in the range between 100° C. and 105° C. The final temperature of the membrane or in the interspace, at the end of the cooling process, can be in particular between 15° C. and 30° C., in general ambient temperature. The cooling process is preferably carried out relatively rapidly, in particular with a temporal temperature change in a range from approximately 0.6° C./s to 2.6° C./s.

As cooling medium, it is possible to use substantially any desired media, in particular gases. However, in general, identical media or media with similar composition can also be considered for the cooling medium, such as the already mentioned media such as air, protective gas or inert gas, as well as the conditioning medium and/or the filling gas as such. In particular, the conditioning medium can thus be used, by cooling, as cooling medium, and gaseous cooling medium can be used as permanent filling gas. However, it is also possible to provide separate process steps and/or different media for conditioning/stretching, cooling, and filling. For drying the gaseous cooling medium, it is also possible to use similar or also the same methods or devices as for the gaseous conditioning medium.

During the procedure, the conditioning medium can be supplied to the at least one interspace from an overpressure container that is fed from a compressor, and designed for an overpressure of preferably 1.5 bar to 2.0 bar. Alternatively or additionally, it is possible to remove the conditioning medium passed through the at least one interspace at least partially via an underpressure generator, preferably via an underpressure container connected downstream of said underpressure generator, wherein an underpressure of preferably 5 mbar is generated.

The use of an overpressure container has the advantage that the conditioning medium can be passed through the interspace at a particularly constant and uniform volume flow. Furthermore, the volume flow, and/or the underpressure and/or overpressure existing in the interspace can be regulated and set relatively finely, particularly when appropriate valves and appropriate control units and/or regulation units are used. As a result, the volume flow, the underpressure and/or the overpressure can be adjusted in a flexible manner to the respective general conditions, dimensions and/or sizes determined by the panes and/or the membrane(s), such as their length and width sizes, thickness, material composition, mechanical anchoring and connection techniques and the like, so that, for the respective panes-membrane combination, a particularly uniform, preferably optimal stretching can be achieved, without causing damage and/or overloading on the multi-pane element. In particular, by regulation or control means, the overpressure or underpressure existing in the respective interspace can be regulated or controlled in such a manner that, in particular in each case relative to the normal atmospheric pressure, damage or overloading on the multi-pane element can be prevented. In the process, as already indicated, the overpressure and/or underpressure can be maintained in a range that is advantageous or acceptable for mechanical anchorings such as sealings, weather strips, bonded joints, etc. The underpressure or overpressure permissible for the respective mechanical anchorings, etc., can depend, for example, on the materials used, such as adhesives, and particularly also on the size or extent of the mechanical anchorings, for example, gluings, and it can be adjusted accordingly by a regulation and/or control. In addition, by means of the pressure container, a respective desired or set volume flow can be maintained substantially independently of any changes in performance of a fan or compressor. The situation is similar in the case of the use of an additional underpressure container described further below. The overpressure container can be designed for an overpressure in the range of 1.5 bar to 2.0 bar, for example.

The underpressure generator can be, for example, a suction fan or a vacuum pump, by means of which the conditioning medium can be removed from the at least one interspace. The underpressure generator is preferably designed for generating an underpressure of approximately 5 mbar.

With the underpressure container, particularly in combination with the overpressure container, the volume flow of conditioning medium flowing through the interspace(s) and/or the pressure of the conditioning medium to which the membrane is exposed can be regulated, in particular set, even more precisely. For the regulation of the conditioning medium taken up by the underpressure container or removed therefrom, it is possible to use one or more valves, in particular metering or throttle valves. By appropriate settings of the valves, in particular of the metering or throttle valves, the volume flow can be set particularly precisely and adjustably, so that desired or required volume flows and flow equilibriums are reached in each case.

By analogy with the advantages of the compressor, it is also possible to prevent pressure variations in the conditioning medium, caused, for example, by changes in performance of the underpressure generator, by connecting the underpressure container downstream of the underpressure generator.

In an embodiment of the method, the exposure to conditioning medium can occur in a housing, and the conditioning medium can be run preferably in a closed loop that includes the housing. Here, the conditioning medium can preferably be removed from the housing, preferably via a compressor, and after exposure of the membrane, preferably via an underpressure generator, it can preferably be returned back into the housing.

According to claim 11, a manufacturing method for a multi-pane element, which comprises at least two panes and at least one membrane located between adjacent panes, is provided, wherein the above-described method, in particular embodiments thereof, is carried out.

For advantages and advantageous effects, reference is made in particular to previous explanations. In particular, the manufacturing cost for the multi-pane element can be reduced in comparison to conventional manufacturing methods, and the quality of the multi-pane element can be improved in particular in regard to the membrane stretching. Not only cost advantages, but also technical advantages, such as a particularly effective and satisfactory stretching of the membrane, can be achieved in a relatively simple manner.

In particular for insulation glass panes or windows or doors, after sufficient stretching and a possible subsequent cooling of the membrane relative to the environment, the interspace can be sealed, in particular in a moisture-tight and/or gas- or air-tight manner. As a result, it is possible to achieve the desired or required insulation effect, among others. The sealing can occur if the interspace is filled with an appropriate concentration of a filling medium, in particular an inert or protective gas, or a gas mixture of appropriate composition. Here, it is particularly advantageous to use the filling medium as conditioning medium, at least in the end phase during the process step of stretching the membrane. The filling medium can be used not only in the end phase, but also for the entire duration of the tensioning or of the stretching of the membrane, as conditioning medium or as main component in the conditioning medium. To the extent required, the composition of the conditioning medium can be adapted in the end phase, in such a manner that the desired final composition or final concentration of filling medium is obtained in the interspace, so that the interspace can be sealed immediately following the stretching of the membrane. In particular, by means of such a seamless method, oxidation or degradation of the pane surfaces and/or of the membrane surfaces and other detrimental effects can be prevented. For sealing the at least one interspace, cuts provided for the exposure to conditioning medium can be sealed.

Alternatively to the above variant, the at least one or at least one interspace can also be evacuated and subsequently sealed.

According to claim 13, a device for stretching at least one membrane arranged between two panes is provided.

The device comprises a stretching unit for stretching the at least one membrane. The stretching unit is designed in such a manner that the membrane, in order to be stretched, can be exposed to a conditioning medium passed through at least one interspace between one of the panes, on the one hand, and the membrane, on the other hand, and/or between two adjacent membranes. The conditioning medium can be formed as described further above. Furthermore, the stretching, as described further above, can be carried out by an appropriate process, in particular a physical and/or chemical process. For further details regarding the stretching and the passage of the conditioning medium through the at least one interspace, reference is made to previous explanations.

Furthermore, the device comprises at least one overpressure container which is designed for the intermediate storage and delivery of compressed conditioning medium, and which comprises a first interface for supplying the conditioning medium into the at least one interspace.

The overpressure container is thus designed and provided in particular to hold in reserve compressed conditioning medium and deliver it as needed. The first interface can optionally be connected to the overpressure container via pipes, lines, tubes and the like. For controlling the delivery of the conditioning medium, a valve, in particular a metering valve or a throttle valve, can be provided directly at the interface and/or between the interface and the overpressure container. For advantages of the overpressure container and of the valves, reference is made to previous explanations.

Moreover, the device can comprise an overpressure generator, in particular a compressor, which is designed for compressing the conditioning medium, and which is connectable to at least one of the at least one overpressure container preferably designed for an overpressure in the range from 1.5 to 2.0 bar, for supplying the compressed conditioning medium. A filter designed for filtering the conditioning medium, and arranged preferably between the compressor and a suction interface of the compressor, can preferably be connected downstream of the compressor.

Alternatively, it would also be conceivable for the overpressure container to be a refillable overpressure container, such as a gas bottle, which can be replaced after emptying with a correspondingly filled overpressure container.

By filtering the conditioning medium, the introduction of foreign substances and contaminants into the interspaces can be avoided.

In an embodiment, the device can moreover comprise at least one temperature control unit for heating and/or cooling and/or adding or removing moisture to or from the conditioning medium. It is preferable for the at least one temperature control unit to be connected preferably directly downstream or upstream of one of the overpressure containers. In particular, it is possible to interconnect a first temperature control unit between compressor and overpressure container, and a second temperature control unit between overpressure container and the first interface.

A heating of the conditioning medium can occur, particularly in the case of heat shrinkable membranes, until a sufficient stretching thereof has been achieved. After a sufficient stretching of the membrane, the conditioning medium can be cooled, in order to adjust the membrane and optionally the panes to a desired final temperature, for example, ambient temperature.

The temperature control unit can comprise a function for setting the humidity of the conditioning medium. This means that, with this additional function, the conditioning medium can be conditioned with regard to the humidity.

The heating of and/or the addition or removal of moisture to or from the conditioning medium can occur as a function of the respective constitution and the stretching properties of the membrane. In general, the conditioning medium can be prepared or conditioned, in particular heated, dried, etc., in such a manner that the membrane reaches a desired or predetermined stretching, for example, in the shortest possible time. Here, the temperature, humidity, etc., of the conditioning medium can be changed or adapted during the course of the stretching, if required, in accordance with an optimal procedure. In addition, other specifications in connection with the stretching are also possible. In the case of a stretching of the membrane, in particular a thermal stretching, stretching temperatures up to 80° C. or up to 90° C. or in the range between 100° C. and 105° C. or higher can be used.

The removal of moisture from or the drying of the conditioning medium can occur, for example, by removing water by condensation. For this purpose, an absorption chiller or a compression chiller can be used, for example. However, it is also possible to use drying, optionally with the addition of a hygroscopic material that is contained, for example, in a container through which the conditioning medium is passed.

By drying and/or filtering the conditioning medium, it is possible in particular to prevent substances from depositing or accumulating in the interspaces exposed to the conditioning medium, which can potentially lead to degradation, turbidity or condensation. For example, by drying it is possible to prevent moisture from collecting in the interspace, or any residual humidity can be removed from the interspaces, the pane and the membrane by the dry conditioning medium.

However, it should be noted that the first and second temperature control units can also be connected downstream of the overpressure container. The first temperature control unit can be, for example, a preheater or a precooler, and the second temperature control unit can be a postheater or postcooler. The use of two temperature control units allows a particularly precise and possibly rapid setting of the respective required or desired temperature of the conditioning medium. By using two temperature control units it is also possible optionally to prevent the occurrence of temperature variations that are detrimental to the stretching process.

In a further embodiment, the device can moreover comprise at least one underpressure generator designed preferably for generating an underpressure of approximately 5 mbar, preferably a suction fan and/or a vacuum pump, for removing the conditioning medium from the at least one interspace. The underpressure generator comprises a second interface for removing the conditioning medium passed through the at least one interspace. Furthermore, the device comprises at least one underpressure container which is designed for receiving the conditioning medium passed through the at least one interspace, and which is preferably interconnected between the underpressure generator and the second interface.

By means of such an underpressure generator, the volume flow of the conditioning medium through the at least one interspace can be set even more precisely, in particular if an additional valve, in particular a metering valve or a throttle valve, is connected between the underpressure generator and the second interface.

With the underpressure container, in particular in combination with the overpressure container, the volume flow of conditioning medium flowing through the interspace(s) and/or the pressure of the conditioning medium to which the membrane is exposed can be regulated, in particular set, particularly precisely. For the regulation of the conditioning medium received from the underpressure container or drawn therefrom, the second interface can comprise a valve, in particular a metering or throttle valve. It is also possible to interconnect a valve, in particular a metering or throttle valve, between the second interface and the underpressure container. By appropriate settings of the valves, particularly of the metering or throttle valves, the volume flow can be set particularly precisely and adjustably, so that respective desired or required volume flows and flow equilibriums are reached.

The valves, as well as all the valves already mentioned further above and further below, in particular metering or throttle valves, can comprise, for the setting thereof, actuators, for example, servomotors, by means of which, optionally taking into consideration the respective formats of the panes-membrane units, as well as suitable measurement values from sensors, for example, pressure sensors, an automatic setting of the volume flow is possible, in particular by means of an electronic control or regulation unit. For further automation, temperature sensors for measuring the temperature of the conditioning medium can also be provided. The temperature sensors can be arranged, for example, in the area of the inlet and/or of the outlet of the conditioning medium in or from the interspaces. Using the measurement values of the temperature sensors, the at least one temperature control unit can be controlled or regulated accordingly.

By analogy with the advantages of the compressor, it is possible to prevent pressure variations in the conditioning medium, which are caused, for example, by changes in performance of the underpressure generator, by connecting the underpressure container downstream of the underpressure generator.

In a further embodiment, the device can moreover comprise a housing which is designed for receiving a panes-membrane unit, and which preferably comprises a support bench formed for the support of the panes-membrane unit, wherein, in particular, a suction interface of the compressor is connected to the interior of the housing, and wherein an outlet interface of the underpressure generator is preferably also connected to the interior of the housing.

By means of a housing it is possible, on the one hand, to clearly reduce influences of the environment, such as temperature variations, soiling and the like. Furthermore, the housing can be sealed in such a manner that, and manufactured from materials such that, said housing is at least substantially impermeable to the respective conditioning medium used. By means of such a sealed housing it is possible to run the conditioning medium in a closed loop. For this purpose, the compressor and/or the underpressure generator can be designed, for example, so that a suction interface of the compressor and optionally an outlet interface of the underpressure generator are connected to the interior of the housing. In this configuration, the compressor can suction the conditioning medium from the housing, while the underpressure generator injects the conditioning medium again into the housing. In the case of such a recirculation of the conditioning medium, when using a filter, the stretching of the membrane can occur with a relatively pure conditioning medium. Furthermore, in the case of such a recirculation, the absolute consumption of conditioning medium can be reduced considerably, since the conditioning medium, at least a portion thereof, can be reused. In particular, if the conditioning medium is a special inert or protective gas, it can be advantageous to reuse the conditioning medium, also taking into consideration the question of cost.

In a further embodiment variant, the first interface can be movable using a first suspension arranged preferably in the housing, and/or the second interface can be movable using a second suspension arranged preferably in the housing, in at least one dimension, in particular in a vertical direction and/or in at least one horizontal direction.

Using the above-mentioned suspensions, a relatively simple positioning of the first and second interfaces is possible. In addition, it is particularly advantageous if the suspensions are designed, for example by including stop mechanisms, in such manner that the first and/or second interface(s) can be fixed or stopped in respective desired positions.

In yet another embodiment variant, the device can comprise at least one first lance which is connectable or connected to the first interface, and insertable into at least one interspace, preferably a first multiple lance, which is formed for supplying the conditioning medium into at least one interspace. In addition or alternatively, the device can moreover comprise at least one second lance which is connectable or connected to the first interface, and insertable into at least one interspace, preferably a second multiple lance, which is formed for removing the conditioning medium from the at least one interspace (22). The at least one first and/or second lance can comprise along its/their longitudinal extent a plurality of openings for the delivery or reception of a conditioning medium.

By means of such lances or multiple lances, which can be inserted into the interspaces, the conditioning medium can be passed into and through the interspaces in a targeted, particularly effective and defined manner.

For the respective longitudinal or transverse extent of the panes and/or membrane, the lances can have a corresponding length, so that, in the case of an arrangement of the lances parallel to and approximately in the edge area of the panes and membrane, a substantially uniform exposure of the entire membrane to the conditioning medium can occur. In particular, one application possibility of such lances is to insert the lances into relatively small openings into a pane-membrane-pane element which, apart from that, is already sealed on the edge side, and to pass the conditioning medium via the lances through the interspace for stretching the membrane. It is particularly advantageous to provide two openings for each interspace, which are located on the end face at mutually separate outer edge areas of the pane-membrane-pane element, and into which the lances can be inserted. Because in this case, substantially the entire membrane can be exposed evenly to the conditioning medium, particularly by over coating. Other arrangements of openings and a different number of openings per interspace are also possible. A particularly effective stretching is possible, if corresponding openings are provided for each interspace.

After the stretching of the membrane has occurred, the lances can be removed from the openings or the interspaces. To the extent that the pane-membrane-pane element was or is already sealed on the edge side, it is only necessary to seal the openings for completely sealing the interspaces. In particular, it follows from this that when lances are used in connection with the above described openings, the manufacturing process for a multi-pane element can be simplified and a cost advantage can be achieved. In the case of an appropriate process management, the number of process steps can be reduced in particular.

As already mentioned, it can happen that, due to the construction, the panes and the at least one membrane located in between can be held by a frame which runs at least partially around the edges of the panes. In this case, it is possible to pass the conditioning medium through the cuts or openings of the frame, even without lances. Here it is possible to provide and design the cuts and optionally the frame in such a manner that the conditioning medium can be passed in direct current or countercurrent through the interspaces.

According to a further embodiment, the device can comprise at least one valve which is connected downstream and/or upstream of the overpressure container, the compressor, the underpressure container and/or the underpressure generator, in particular a metering or throttle valve, which is designed for controlling or regulating the flow of conditioning medium through the at least one interspace and/or for controlling or regulating the underpressure or overpressure existing in the interspace. This can occur preferably as a function of the respective format and/or properties of the panes-membrane unit, particularly preferably by means of an electronic control or regulation unit. As properties of the panes-membrane unit, one can consider in particular general conditions determined by the panes and/or the membrane(s) as well as by the panes-membrane unit. The following can be mentioned here, as examples, in a list that is not comprehensive: dimensions and/or sizes, such as length and width sizes, thickness, material composition, mechanical anchoring and connection techniques, such as type of adhesive, bonding techniques, bonding dimensions, and the like.

In the process described further above for stretching at least one membrane arranged between two panes, and in the manufacturing method, it is possible to use in particular the above described device or any desired embodiment thereof. In the process, the conditioning medium can be supplied in particular from overpressure container supplied by a by a compressor, at an overpressure of preferably 1.5 bar to 2.0 bar, to the at least one interspace.

For stretching the membrane, as already mentioned in part, it can be particularly advantageous to heat the conditioning medium by means of at least one temperature control unit, preferably in such a manner that a stretching temperature of up to 80° C. or up to 90° C. or in the range from 100° C. to 105° C. or higher can be reached, wherein a first temperature control unit is preferably connected downstream of the underpressure container, and a second temperature control unit is preferably connected upstream of the overpressure container. After stretching the membrane, the latter can be cooled to a desired final temperature, by operating at least one of the at least one temperature control unit as a cooling unit.

The multi-pane element mentioned in connection with the invention and its embodiments thereof can be in particular an insulation glass pane or an insulation window or an insulation door. By the effective and advantageous stretching of the membrane, the manufacturing cost of the multi-pane element can be reduced in comparison to conventional manufacturing methods, and the quality of the multi-pane element can be improved in particular with a view to the membrane stretching. Not only cost advantages, but also technical advantages, such as a particularly effective and good tensioning of the membrane, can be achieved in a simple manner.

In particular for insulation glass panes or windows or doors, the interspace, after sufficient stretching of the membrane, can be sealed from the environment, in particular in a moisture-tight and/or gas- or air-tight manner. As a result, the desired or required insulation effect can be achieved, among others. The sealing can occur if the interspace is filled with a suitable concentration of a filling medium, in particular inert or protective gas, or a gas mixture of appropriate composition. Here, it is particularly advantageous, at least in the end phase during the process step of the tensioning of the membrane, or during the cooling thereof, to use the filling medium as conditioning medium, or to admix or add by metering said filling medium to the conditioning medium. However, the filling medium can be used not only in the end phase, but also for the entire duration of the stretching and/or cooling of the membrane, as conditioning medium or as main component of the conditioning medium. To the extent required, in particular in the end phase, the composition of the conditioning medium can be adapted in such a manner that, in the interspace, the desired final composition or final concentration of filling medium is reached, so that the interspace can be sealed immediately following the stretching and optional cooling of the membrane. In particular, by means of such a seamless method, oxidation or degradation of the pane surfaces and/or of the membrane surfaces, and other detrimental effects can be avoided.

Overall, it has been shown that, using the device, in particular according to one of the above described embodiments, a particularly effective and in particular a relatively rapid stretching of the membrane is possible. Owing to the possibility of direct exposure of the membrane to conditioning medium, in particular, the stretching can occur in a particularly energy efficient manner.

In a further embodiment, it is possible, in particular by means of the already described valves and/or variable provision in the containers and/or the control or regulation device, to adapt the volume flows of the conditioning medium to different volumes, for example, thicknesses or widths or heights, of the interspaces between the panes.

It should be noted that, in particular, all the previously mentioned and described characteristics, are usable accordingly for the method, the manufacturing method or the device or embodiments thereof, although this has not been mentioned explicitly.

Below, embodiment examples of the invention are explained further in reference to the appended figures.

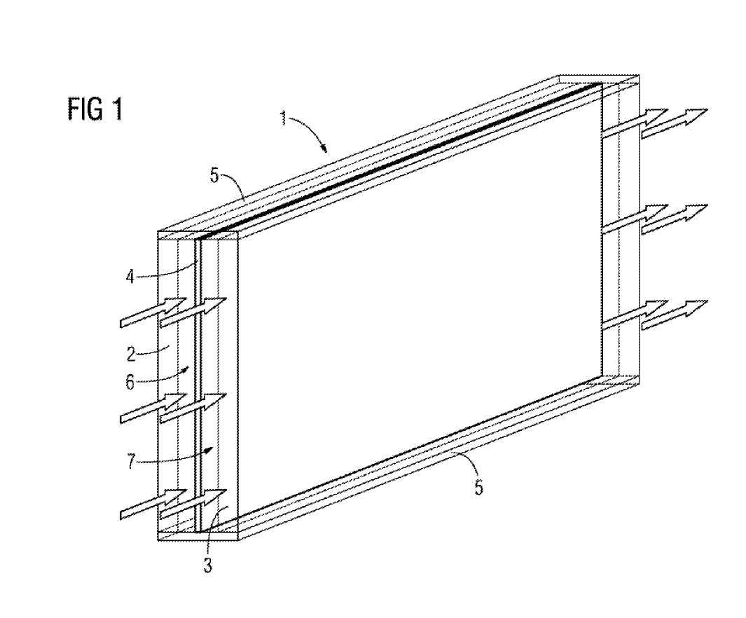

FIG. 1 shows diagrammatically an insulation glass in a perspective representation;

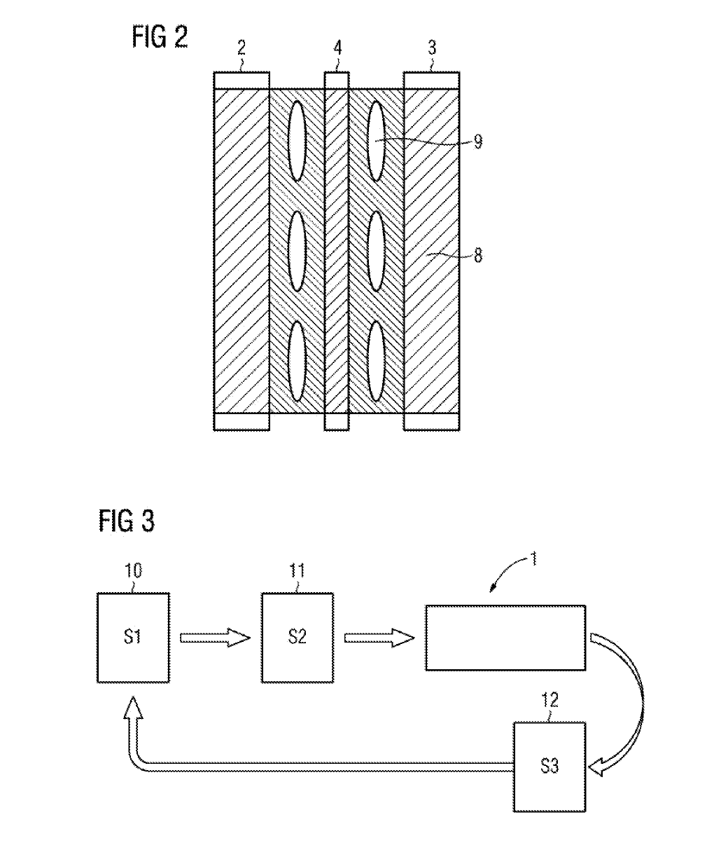

FIG. 2 shows a face-side view of the insulation glass;

FIG. 3 shows diagrammatically a procedure for a method for stretching a membrane;

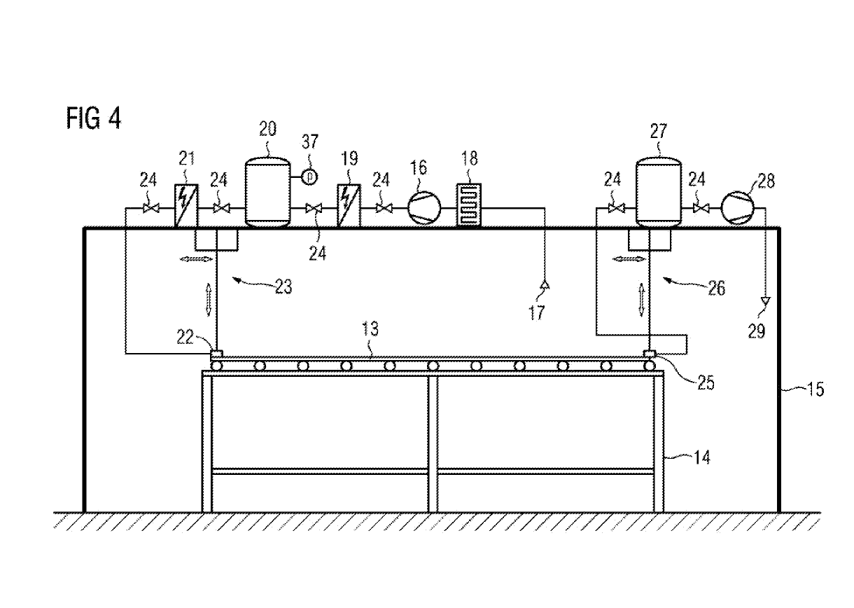

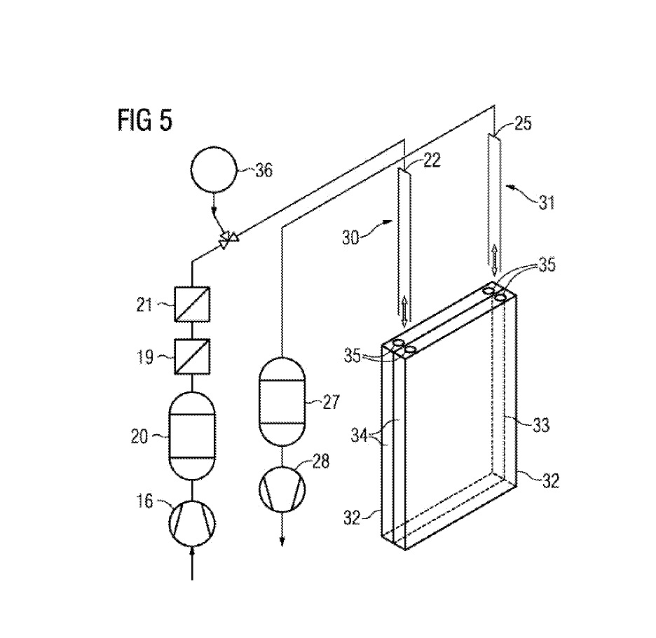

FIG. 4 shows diagrammatically a device for stretching a membrane of a multi-pane element;

FIG. 5 shows details of an embodiment of a device for stretching a membrane of a multi-pane element in a first operating state;

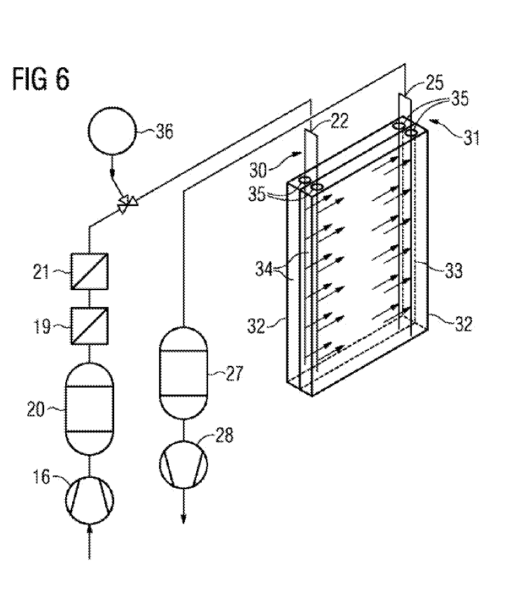

FIG. 6 shows details of the device in a second operating state; and

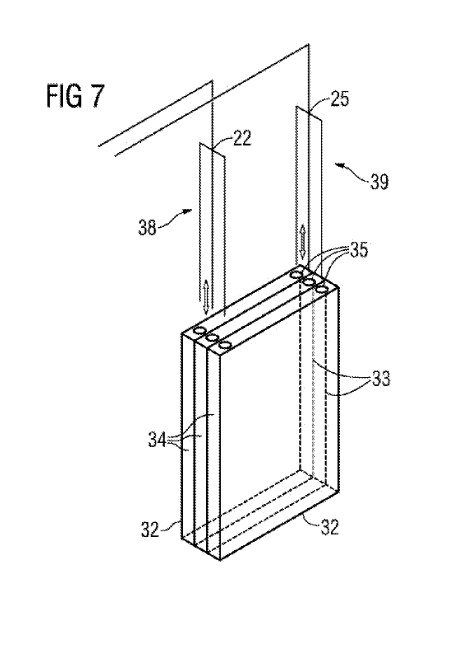

FIG. 7 shows details of an additional embodiment of the device.

In the figures, identical or functionally equivalent elements are marked with identical reference numerals. The embodiments described in connection with the figures are described only to the extent necessary for the understanding of the invention. Furthermore, the figures are not necessarily true to scale, and the scales can vary between the figures.

FIG. 1 shows an example of an insulation pane element 1 in a perspective representation, which is also referred to/below as insulation glass 1 for short, although the panes do not necessarily have to be made of glass, but can also be made from another transparent material or glass substitute material. The insulation glass 1 comprises a first pane 2 and a second pane 3. The first pane 2 and second pane 3 can be manufactured, for example, from glass or also from a glass substitute material. The first pane 2 and second pane 3 are arranged parallel to each other, wherein the first pane 2 is spaced from the second pane 3.

Approximately midway between the first pane 2 and second pane 3, a film 4 is located. The film 4—in accordance with the orientation of FIG. 1—is held by upper and lower frame elements 5.

By means of the film 4, the space is subdivided between the first pane 2 and second pane 3, as a result of which the insulation effect of the insulation glass can be increased, with simultaneous weight reduction compared to insulation glasses having three panes. The film 4 can also be used for other purposes. For example, color effects can be generated by dyeing the film and/or the overall transmission properties of the insulation glass 1 can be influenced by coating the film. For example, the insulation glass 1 can be made largely impermeable to ultraviolet radiation and/or infrared radiation by an appropriate coating, in particular of the film 4. Furthermore, using appropriate coating materials, it is possible to apply a reflective coating to the insulation glass 1, at least in partial areas.

For the transmission properties of the insulation glass 1 not to be affected by wave or fold formation of the film 4, regardless of coatings that may be present, it is necessary to stretch the film to a sufficient extent.

Such a stretching can occur mechanically, at least partially, for example by means of the frame elements 5. However, it has been shown that a stretching by the frame elements 5 alone, for example, by mechanical mechanisms, is not particularly effective.

In the present case, the film 4 is also heat stretchable, which means that the film 4 can be stretched by supplying heat energy, due to either isotropic or anisotropic contraction of the film 4 due to heat exposure.

It has been shown that stretching the heat stretchable film 4 by exposure to heat radiation through the first pane 2 or second pane 3 also has a low energy efficiency. Here, the first pane 2 or second pane 3 acts as heat shield, so that such a stretching consumes an enormous amount of time and energy. If the first pane 2 or second pane 3 is left off at first, the film 4 can be exposed to heat radiation without the shielding effect of the corresponding pane; this requires a stepwise construction, which is also relatively time consuming.

According to the invention, these disadvantages are eliminated, for example, by exposing the film 4 to be stretched to a conditioning gas, wherein the conditioning gas is led through an interspace between the first pane 2 and the second 3 pane, so that the film 4 can be exposed directly to the conditioning gas.

In concrete terms, the conditioning gas is led through a first free space 6 formed between the first pane 2 and the film 4, and through a second free space 7 formed between the film 4 and the second pane 3, wherein the flow of the conditioning gas is indicated by arrows in FIG. 1.

In the present case, the conditioning gas is run by the film 4 on both sides. It is also possible run the conditioning gas by the film 4 on only one side. If more films 4 and/or panes are present than those shown in FIG. 1 merely as an example, all the free spaces between a pane and a film 4, or between two films 4, can be used jointly or selectively for the passage of the conditioning gas.

In the example of FIG. 1, the conditioning gas is introduced at the front side by means of a supply unit which is not shown, and it exits again at the rear side in the view of FIG. 1. In this case there are no frame elements 5 at the in- and outlet. At the outlet, the conditioning gas can be released into the environment. However, it is also possible to collect the conditioning gas. This is particularly advantageous if the conditioning gas is to be reused and regenerated, or if it would have harmful or toxic effects on the environment.

For stretching the film 4, the conditioning gas is heated prior to introduction into the first 6 and second 7 free spaces, in particular in such a manner that a stretching temperature dependent on the material of the membrane or film 4 of, for example, 80° C. to 90° C. or 100° C. to 150° C. or higher is reached, and it is in particular also dried. The hot and dry conditioning gas then flows through the free spaces 6 and 7, wherein the film 4 is exposed directly to the conditioning gas. It has been shown that, due to this direct exposure of the film 4 to the appropriately conditioned, i.e., in the present case hot and dry, conditioning gas, a particularly effective stretching of the film 4 can be achieved. It is particularly within the scope of the invention for the stretching to occur by direct exposure of the film 4 to a conditioning gas flow, in addition to the mentioned mechanical stretching and the stretching by heat radiation.

Depending on the constitution and the properties of the film 4, the conditioning medium can also be conditioned in another manner in addition or alternatively to heating and drying. For example, it is conceivable to bring about a stretching of the film 4 by interaction with a substance, for example, a chemical substance. In this case, a conditioning of the conditioning gas can consist, for example, of setting an appropriate concentration of the substance in the conditioning gas.

In FIG. 1, frame elements 5 located at the top and at the bottom are shown. These frame elements 5 are used, on the one hand, for holding the first pane 2 and second pane 3 at a predetermined distance apart. Furthermore, in the present case, the film 4 is held by the frame elements 5. In addition to the frame elements 5 shown, additional frame elements, which are not represented, can be arranged on the end faces—located in the flow direction—i.e. at the in- and outlet, of the insulation glass 1. They can also be used for holding panes 2, 3 and film 4.

An additional frame element 8 is represented diagrammatically in FIG. 2. This additional frame element 8 here covers the front face-side of the insulation glass 1 of FIG. 1, i.e., the inlet for the conditioning gas. In the additional frame element 8, cuts 9 are present, through which the conditioning gas can be led into the free spaces 6 and 7. After successful stretching of the film 4, the cuts 9 can be closed in a gas- and fluid-tight manner, for example. A similar additional frame element can be provided at the outlet. The cuts 9 and/or the additional frame elements 8 can be designed and arranged in such a manner that the conditioning gas can be passed in direct current or countercurrent through the free spaces 6 and 7.

As conditioning gas, air can be used, for example, in particular ambient air. If needed, this air can also be filtered, prior to the introduction into the free spaces 6 and 7.

After the stretching of the film by the conditioning gas, in order to achieve a rapid cooling, in particular for a subsequent filling step, it is also possible to pass, in a cooling step, a cooling medium, particularly cooling gas, through the free spaces 6 and 7 between panes 2, 3 and the film 4. To this effect, the cooling gas is first adjusted to a cooling temperature, or its temperature is regulated according to a predetermined cooling temperature curve having preferably a decreasing cooling temperature, for example, from the stretching temperature of 90° C., for example, to a final temperature of typically between 5° C. and 30° C., and is preferably also conditioned with a predetermined correspondingly low residual humidity. It is preferable for the cooling gas to be introduced in the same manner as the conditioning gas, particularly through the cuts 9, which are then permanently closed only after the cooling step or optionally after a step following the cooling step. The cooling gas can be in particular the same gas as the conditioning gas, for example, ambient air.

Frequently the free spaces 6 and 7 formed between panes 2, 3 and the film 4 are (permanently) filled with an inert or protective gas. This can lead, on the one hand, to the improvement of the insulation properties of the insulation pane element or insulation glass 1. On the other hand, it is also possible to prevent, at least to some extent, a degradation of film 4 and/or inner surfaces of the panes 2 and 3.

Using the method according to the invention, it is also possible to use the respective inert or protective gas as conditioning medium, or as cooling agent if one is used, at least in an end phase during the stretching or cooling of the film 4, so that the free spaces 6 and 7, after the stretching has taken place and after optional cooling, are already filled with inert or protective gas. Therefore, during the manufacture of the insulation glass 1, a separate filling step for the inert or protective gas can be omitted.

Furthermore, a coating material can be added to the conditioning gas, which can be air, inert gas or protective gas. The coating material can have a specific affinity for the film 4 or for the first pane 2 and/or second pane 3, particularly their optionally pretreated inner surfaces. In this manner, it is possible to coat the film 4 and/or the first pane 2 or second pane 3, in particular specifically. Coating materials can include, for example, dyes, ultraviolet-absorbing materials, infrared-absorbing materials and/or materials for sealing and for antireflective coating of the film 4 and/or the first pane 2 or second pane 3, etc.

FIG. 3 shows diagrammatically a possible procedure for stretching the film 4. In a first step S1, the conditioning gas is provided, for example, in a storage tank 10. The conditioning gas can be, in particular, air, inert or protective gas, or a mixture thereof. The conditioning gas is conditioned in a second step S2 by means of a conditioning device 11. This second step can comprise the following partial steps, which can be carried out consecutively, simultaneously, or in a limited time window, during the stretching process: drying of the conditioning gas, heating of the conditioning gas, and filtering of the conditioning gas. Optionally, in the second step, for example, in the end phase of the stretching, a coating material can also be added to the conditioning gas; this is preferable to do this in the case of the filtered conditioning gas. For this purpose, the conditioning device 11 can comprise heating devices, drying devices, filtering devices or admixing devices for admixing a coating material, which are not represented.

The drying and heating of the conditioning gas occur in particular with the purpose of stretching the film 4, while the filtering and the admixing of the coating material are used preferably to prevent the degradation of film 4 and panes 2 and 3 or for finishing.

The drying of the conditioning gas can occur, for example, by means of an absorption chiller, a compression chiller and/or using a hygroscopic material.

After conditioning the conditioning gas in the second step, said conditioning gas is led through the insulation glass 1, wherein a stretching of the film 4 occurs, and, if any coating materials are added to the conditioning gas, the film 4 and/or inner surfaces of the panes 2 and 3 are coated with a coating film. The conditioning gas can be led, for example, via cuts 9, as shown in FIG. 2, into the free spaces 6 and 7. In a corresponding manner, the conditioning gas can be removed, for example, on an opposite end face. For this purpose, appropriately designed supply and removal devices are provided, which have corresponding connection and securing pieces, and which can be coupled to the cuts 9. The conditioning gas can be discharged into the environment. However, in the method according to FIG. 3, it is provided to collect the conditioning gas in a step S3, and to make it available for reuse, preferably after regeneration and processing. For this purpose, a regeneration unit 12 can be provided. Thus it is possible, as diagrammatically indicated by the arrows in FIG. 3, to set up a circulation process for the conditioning gas with corresponding cost advantages.

The conditioning gas is passed through the free spaces 6 and 7, for example, by means of a pump device or a ventilation system which is not represented explicitly, until a sufficient stretching of the film 4 has been achieved. Depending on the requirements of the coating processes, the conditioning gas can also be passed for a longer or a shorter duration through the free spaces 6 and 7, wherein, in the latter case, one of the above-mentioned additional stretching mechanisms should be made available, so that a sufficient stretching of the film 4 can be achieved.

In the same way, if desired, following the stretching of the film 4 with the conditioning gas, the cooled or preferably dried cooling gas can also be introduced into the free spaces 6 and 7 through the cuts 9 in the frame 8 and discharged again.

After sufficient stretching and optional cooling of the film 4, the cuts 9 can be closed, so that the free spaces 6 and 7 are sealed from the environment. For this purpose, a sealing unit which is not represented is used. To the extent that the free spaces 6 and 7 are to be filled with inert or protective gas, this can occur, for example, in an additional filling step. If, as conditioning gas or cooling gas, the desired inert or protective gas is already being used, the separate filling step is omitted, and the cuts 9 can be closed immediately after the stretching of the film 4.

FIG. 4 shows in a diagrammatic manner a device for stretching a membrane of a multi-pane element 13, which can be an insulation glass pane. The multi-pane element 13 lies on a roller table 14, which is arranged in a housing 15. The housing 15 is dimensioned such that the multi-pane element 13 can be accommodated completely in it. Furthermore, the housing 15 is formed so that it can be closed relative to the environment, preferably in a pressure-tight manner.

For stretching the membrane with a conditioning medium, such as air, inert gas or protective gas, the device has a stretching unit whose design and function are described in further detail below.

The stretching unit comprises substantially two subunits, more precisely a first subunit for supplying the conditioning medium and a second subunit for discharging the conditioning medium.

The first subunit comprises a compressor 16. On the inlet side, the compressor 16 is connected to a suction interface 17 located in the interior of the housing 15, via lines that are passed in a gas-tight manner through the wall of the housing 15. For filtering the conditioning medium, a filter 18 is interconnected between compressor 16 and suction interface 17.

On the output side, a first temperature control unit 19, an overpressure container 20, and a second temperature control unit 21 are series connected downstream of the compressor 16. The first temperature control unit 19 can be operated as a preheater or precooler, depending on the operating mode. The second temperature control unit 21 can then be operated as a postheater or postcooler, depending on the operating mode.

On the output side, the second temperature control unit 21 is connected in a gas-tight manner via lines that are passed through the wall of the housing 15 to a first interface 22 located in the interior of the housing 15.

The first interface 22 is connected to a first suspension 23 arranged in the interior of the housing. The first suspension 23 is designed in such a manner that the first interface 22 can be shifted in vertical and in horizontal directions, indicated by double arrows, and stopped and fixed in the respective position and orientation.

Between the second temperature control unit 21 and the first interface 22, a throttle valve 24 is interconnected, by means of which the pressure and volume flow of conditioning medium to which the first interface 22 is to be exposed can be set. Additional valves and throttle valves, which are also marked with the reference numeral 24, can be arranged in particular between second temperature control unit 21 and overpressure container 20, between overpressure container 20 and first temperature control unit 19, and between first temperature control unit 19 and compressor 16, and at other appropriate sites. A control or regulation unit (not shown) can be provided in order to regulate or to control the valve(s) or throttle valve(s) 24 in accordance with the respective requirements, in particular the format and the properties of the panes-membrane unit.

The second subunit comprises a second interface 25, which is attached to a second suspension 26 corresponding in terms of function and arrangement to the first suspension 23. In particular, the second suspension 26 is designed in such a manner that the second interface 25 can be moved in vertical and in horizontal directions, indicated by double arrows, and it can be stopped and fixed in the respective desired position and orientation.

The second interface 25 is connected via lines which are passed in a gas-tight manner through the wall of the housing 15 to an underpressure container 27, for example, a vacuum container. The underpressure container 27 is connected via corresponding lines to the input side of an underpressure generator 28. The underpressure generator 28 can be, for example, a suction fan or a vacuum pump. On the output side, the underpressure generator 28 is connected via lines which are passed in a gas-tight manner through the wall of the housing 15 to an injection interface 29 or an outlet interface, through which outlet air of the underpressure generator can be injected into the housing 15. Valves or throttle valves can be connected downstream and/or upstream of the underpressure container 27 and/or the overpressure generator 28 so that the volume flow generated by the underpressure generator 28 can be set.

The underpressure container 27, in combination with the overpressure container 20 is advantageous in particular to the extent that thereby the volume flow of conditioning medium can be set particularly precisely, for example, for a given format and/or certain properties of the panes-membrane unit, and it can be kept particularly constant. However, it should be mentioned that the underpressure container 27 can also be omitted, wherein, in this case, the underpressure generator 28 is directly connected on the input side, optionally with the interconnection of one or more valves, to the second interface 25, or it can be connected thereto.

FIG. 5 and FIG. 6 show details of an embodiment of a device corresponding to the one shown in FIG. 4 in different operating states. Differences between the device according to FIG. 5 and FIG. 6 and the device shown in FIG. 4 consist particularly in that no filter 6 is provided, and in that both the first temperature control unit 19 and second temperature control unit 21 are connected downstream of the overpressure container 20. However, here too, the use of a filter or of a temperature control unit arranged between the compressor 16 and the overpressure container 20 is possible. Furthermore, the housing 15 is not shown in FIGS. 5 and 6. It should be noted that a housing 15 may offer certain advantages with a view to shielding against potential environmental influences, but a housing is not absolutely required. Moreover it should be noted that, in deviation from the above description, it is also possible to arrange any other portions of the device in the housing 15.

An additional difference compared to the device of FIG. 4 consists of a metering device 36 which, in the present case, is connected via corresponding valves to the line between the second temperature control unit 21 and the first interface 22. With the metering device 36, it is possible to add additional substances by metering, such as, for example, inert gases or protective gases, in a particularly targeted manner to the conditioning medium running in the lines.

As can be seen in FIGS. 5 and 6, the first interface 22 comprises a first double lance 30, and the second interface 25 comprises a second double lance 31. The first double lance 30 and second double lance 31 can be connected to the first interface 22 or second interface 25, for example, in a detachable, particularly an exchangeable, manner via corresponding couplings.

The first double lance 30 and second double lance 31 are adapted in the present case so as to stretch a membrane 33 arranged between two panes 32. The panes 32 and membrane 33 form a multi-pane element in the sense of this application. The membrane 33 is spaced from the panes 32 in such a manner that between the membrane 33, on the one hand, and each pane 32, on the other hand, an interspace 34 is formed in each case. In general, and particularly as a function of the design of the multi-pane element, it is also possible to use only single lances or triple or multiple lances. Triple or multiple lances are considered particularly if three or more than three membranes are to be stretched simultaneously.

The first double lance 30 and second double lance 31 can be inserted into the interspaces 34 of the multi-pane element through corresponding openings 35 provided in pairs. The openings 35, in the present case, are located on an end face of the multi-pane element in the lateral edge-side area, so that in each case a lance tip of the first double lance 30 and a lance tip of the second double lance 31 can be inserted through an opening 35 into the same interspace 34. The panes 32 of the multi-pane element can be held at a predetermined distance, for example, by means of spacers (not shown). The openings 35 can be provided in such spacers. If the spacers comprise a drying agent, which can be contained, for example, in the form of a granulate, or in a plastic matrix in the spacer, appropriate measures should be taken in order to prevent the drying agent from escaping. However, it is preferable to introduce openings 35 in those spacers that contain no drying agent.

FIG. 5 shows the situation before inserting the first double lance 30 and second double lance 31 into the interspaces 34. FIG. 6 shows the situation after inserting the first double lance 30 and second double lance 31 into the interspace 34.

The function of the devices according to FIG. 4 to FIG. 6 is as follows:

By means of the compressor 16, conditioning medium is suctioned out of the housing 15 through the suction interface 17, and filtered as it passes through the filter 18, if one is present. The compressor 16 supplies the overpressure container 20, at a pressure in the range of 1.5 bar to 2.0 bar, for example. From the overpressure container 20, the conditioning medium reaches the first interface 22 via the throttle valve 24 or metering valve. By means of the throttle valve 24, the pressure existing at the first interface 22 and the volume flow of conditioning medium through the interspaces 34 can also be set.

At the overpressure container 20 as well as at other sites of the device, particularly in the interior of the housing 15, pressure sensors 38 can be provided, so that, on the one hand, the pressure in the overpressure container 20, optionally the pressure in the underpressure container 27 and/or pressures in the conditioning medium circulation can be determined. The determined pressures can be used for the in particular automatic control and setting of the conditioning medium circulation. If a semiautomatic or automatic control of the pressures is provided, the throttle valve 24 and optionally additional valves can be set accordingly via actuators.

In particular via the first double lance 30 and second double lance 31 as shown in FIG. 5 and FIG. 6, the conditioning medium is passed through the interspaces 34, indicated in FIG. 6 by corresponding arrows. For injecting or suctioning the conditioning medium into the interspaces, the first double lance 30 and second double lance 31 can comprise several injection or suction openings distributed over the longitudinal direction. In this manner, substantially over the entire membrane 33, a uniform, in particular a defined, conditioning medium flow having in particular approximately parallel flow lines can be maintained.

The suctioning of the conditioning medium through the suction openings occurs through the second double lance 31 exposed to underpressure. This underpressure is generated by the underpressure generator 28, optionally with the interconnection of an underpressure container 27. At the above mentioned overpressure of 1.5 bar to 2.0 bar, the underpressure generated by the underpressure generator 28 can be 5 mbar, for example. The underpressure results in the conditioning medium injected by the first double lances 30 in the area of a longitudinal side of the multi-pane element into the interspaces being suctioned again on the opposite longitudinal side. Thus, a particularly uniform volume flow can be passed over the membrane 33, which can be set particularly by means of the throttle valves in an appropriate manner, resulting, for example, in an optimal residence time of the conditioning medium in the interspaces.

The conditioning medium on the output side is again injected or returned by the underpressure generator 28 into the housing 15, where it can be suctioned again by the compressor 16, etc. In this manner, the conditioning medium can be run in circulation, wherein, if the filter 18 is used, it is subjected to a substantially continuous filtering. Thus, the foreign substance content, for example, dust or other detrimental particles, in particular can be reduced to a minimum.

By means of the described circulation, the conditioning medium is passed through the interspaces 34. For stretching the membrane 33 which in the present case is thermally shrinkable, the conditioning medium is heated by means of the first temperature control unit 19 and second temperature control unit 21 operated as pre- and postheater. In the process, the conditioning medium is heated to a temperature that is particularly well suited for shrinking the membrane 33 with given additional process parameters, such as pressure and volume flow.

After sufficient stretching of the membrane 33, the latter can be cooled again to normal temperature, for example, ambient temperature. In the process, the first temperature control unit 19 and second temperature control unit 21 can be operated as pre- or postcooler. After the cooling has taken place, the first double lance 30 and second double lance 31 can be removed from the multi-pane element. This can occur, for example, manually, or, on the other hand, also automatically, by means of the first suspension 23 and second suspension 26. If the multi-pane element was already closed on the edge side with the exception of the openings 35, the openings 35 can also be closed in a last step, and the interspaces 34 can be sealed from the environment.

If the interspaces 34 of the finished multi-pane element are to be filled with an inert gas or protective gas filling, etc., inert or protective gas and the like can be added by metering using the metering device 36. The addition by metering can here occur for the entire duration of the exposure of the membrane 33 to conditioning medium. It is also possible for the addition by metering to occur only in an end phase, for example, of the stretching or cooling process. Furthermore, it is possible to add by metering inert or protective gas, etc. only after the cooling, and to pass conditioning medium mixed with inert or protective gas for an additional duration through the interspaces 34, until a sufficient concentration of inert or protective gas in the interspaces 34 has been reached.

It has been shown that the described devices, methods and manufacturing methods provide a particularly effective possibility for stretching the membrane 33 of the multi-pane element. In particular, when providing the housing 15 and/or the filter 18, environmental effects and the introduction of foreign substances into the interstices 34 can be largely prevented. Because the membrane 33 is exposed directly to the heated conditioning medium, the energy required for stretching the membrane 33 can be reduced considerably in comparison to known methods. Moreover, due to the direct exposure or heating of the membrane 33 by means of the conditioning medium, the stretching can be achieved in a relatively short time.

Due to the possibility of filling the interspaces 34 with inert or protective gas during or immediately following the stretching process, time advantages can also be achieved in the manufacture of the multi-pane element. Moreover, it should be noted that, in order to prevent damage to the membrane 33 and/or to any coatings present on the panes 32, an additional lance guide can be advantageous. However, a horizontal lance guide is also possible, wherein here, in order to prevent damage, a sufficiently stable lance guide along the horizontal is advantageous, taking into consideration any gravity-caused bending of the membrane 33.

The multi-pane element described in connection with the figures can in particular be an insulation pane. The panes 32 do not necessarily have to consist of glass; instead, they can also be made from another transparent material or glass substitute material. The panes 32 of the multi-pane element in the present case are planar panes 32. However, the device and the corresponding method can also be used in the case of multi-pane elements having any desired curvature, wherein the supply of the conditioning medium here occurs optionally without lances.

The membrane 33 is located approximately midway between the panes 32, and it can be kept in position by holding elements, for example. However, it is particularly advantageous if—as already described above—the multi-pane element is already sealed or welded at least partially on the edge side, and as a result the membrane 33 is already maintained in position in any case.

By means of the interspaces 34 formed on the two sides of the membrane 33, the insulation effect required in the case of an insulation pane can be achieved. To the extent necessary, more than two interspaces 34 can be provided, wherein corresponding multiple lances can be used. The membrane 33 can also fulfill additional functions or optionally other functions. For example, color effects can be generated by dyeing the membrane 33 and/or the overall transmission properties of the insulation pane can be influenced by coating the membrane 33. Furthermore, using appropriate coating materials it is possible to provide the insulation pane at least in partial areas with a reflective coating. The coating elements can be added by metering to the conditioning medium, for example, via the metering device 36.

FIG. 7 shows details of an additional embodiment, relating particularly to the first and second lance. In contrast to FIGS. 5 and 6, the first interface 22 comprises a first triple lance 38 and the second interface 25 comprises a second triple lance 39. Using such multiple lances, it is possible to process panes-membrane units, for example, in which two membranes 33 are arranged between two outer panes 32. In concrete terms, the first triple lance 38 and second triple lance 39 make it possible, in the present example, to adequately expose the interspaces 34 between panes 32 and membranes 33 and the interspace 34 between the membranes 33 to conditioning medium. Beyond the present embodiment example, it is particularly within the scope of the present invention if a multiple lance system is provided with four or more individual lances, so that, in the case of a pane-membrane combination, four or more interspaces between pane 32 and membrane 33, between two panes 32 and/or between two membranes 33, are exposed to conditioning medium.

By means of multiple lance systems it is possible to stretch simultaneously several membranes 33 located in different interspaces. In order to be able to react in a particularly flexible manner to different sizes, particularly thicknesses of the multi-pane elements, and spacings between individual panes 32, it is particularly advantageous if spacings of the lances can be varied transversely to their longitudinal extent. This can occur, for example, by means of appropriate adapters. However, it is also possible to be able to modify spacings of respective adjacent lances continuously or in predetermined increments, particularly dynamically. A similar statement can be made for the length of the lances, i.e., the lances can be designed in such a manner that their length can be increased or shortened by adapters, or that the length of said lances can be modified continuously or in predetermined increments.

### LIST OF REFERENCE NUMERALS

1 Insulation glass
2 First pane
3 Second pane
4 Film
5 Frame element
6 First free space
7 Second free space
8 Additional frame element
9 Cut
10 Storage tank
11 Conditioning device
12 Regeneration unit
13 Multi-pane element
14 Roller table
15 Housing
16 Compressor
17 Suction interface
18 Filter
19 First temperature control unit
20 Overpressure container
21 Second temperature control unit
22 First interface
23 First suspension
24 Throttle valve
25 Second interface
26 Second suspension
27 Underpressure container
28 Underpressure generator
29 Injection interface
30 First dual lance
31 Second dual lance
32 Pane
33 Membrane
34 Interspace
35 Opening
36 Metering device
37 Pressure sensor
38 First triple lance
39 Second triple lance
S1 First step
S2 Second step
S3 Third step

1-12. (canceled)

13. A device for tensioning at least one heat-shrinkable film in a multi-pane element, comprising:
a tensioning unit for tensioning at least one heat-shrinkable film, arranged between two panes in a multi-pane element, by contacting said heat-shrinkable film with a heated gas which is passed through at least one interspace between one of the panes and the heat-shrinkable film and/or between two adjacent heat-shrinkable films; and
at least one overpressure container comprising a first interface to the multi-pane element.

14-20. (canceled)

21. A method for tensioning a film in a multipane window element comprising, contacting at least one heat-shrinkable film arranged between two panes in a multipane window element with a heated gas passed through at least one interspace between the heat-shrinkable film and one of the panes and/or between adjacent heat-shrinkable films to form a tensioned film.

22. The method according to claim 21, wherein the heated gas is passed through interspaces located on the two sides of the at least one heat-shrinkable film.

23. The method according to claim 21, wherein the heated gas is passed through openings in a frame that at least partially encloses the edges of the two panes and wherein the two panes comprise glass or acrylic.

24. The method according to claim 21, wherein the heated gas is supplied to the at least one interspace and/or removed therefrom by at least one lance inserted in the at least one interspace.

25. The method according to claim 24, wherein the at least one lance is a multiple lance.

26. The method according to claim 21, wherein the heated gas has a temperature of 80 to 150° C.

27. The method according to claim 21, wherein the heated gas is dried and/or filtered before contacting the heat-shrinkable film.

28. The method according to claim 21, wherein the heated gas comprises air, argon, krypton, helium, xenon, neon, a protective gas, or a combination thereof.

29. The method according to claim 21, further comprising cooling the tensioned film.

30. The method according to claim 29, wherein the tensioned film is cooled by contact with a cooling gas comprising air, argon, krypton, helium, xenon, neon, a protective gas, or a combination thereof.

31. The method according to 21, wherein the heated gas is supplied to the at least one interspace at a pressure of about 1.5 bar to about 2.0 bar, and is at least partially removed through an underpressure container at a pressure of about 5 mbar.

32. The method according to claim 21 wherein the multipane window element is enclosed within a housing and the heated gas is recirculated to and from the housing.

33. A method for tensioning a film in a multipane window element comprising,
contacting at least one heat-shrinkable film arranged between two panes in a multipane window element with heated air passed through at least one interspace between the heat-shrinkable film and one of the panes and/or between adjacent heat-shrinkable films to form a tensioned film;
contacting the tensioned film with a cooling gas comprising argon or krypton passed through the at least one interface;
filling the least one interface with krypton or argon; and
sealing the at least one interface.

34. A multipane window element comprising at least two panes and a tensioned film prepared by the method of claim 21, wherein the at least one interspace comprises air, argon, krypton, helium, xenon, neon, a protective gas, or a combination thereof.

35. The device according to claim 13, further comprising a compressor, a compressor suction interface, and a filter connected between the compressor and compressor suction interface.

36. The device according to claim 35, further comprising a first temperature control unit connected between the compressor and overpressure container and a second temperature control unit connected between the overpressure container and the first interface.

37. The device according to claim 35, further comprising an underpressure generator comprising a suction fan, vacuum pump, or combination thereof; a second interface to the multi-pane element; and at least one underpressure container connected between the underpressure generator and the second interface to the multi-pane element.

38. The device according to claim 37, further comprising a housing and a support bench wherein the suction interface of the compressor and an outlet interface of the underpressure generator is connected to the interior of the housing.

39. The device according 38, wherein the first interface and/or the second interface is movable vertically, horizontally, or a combination thereof.

40. The device according to claim 39, further comprising at least one first lance and at least one second lance, wherein each lance is insertable into the at least one interspace and comprises a plurality of openings, and wherein the at least one first lance is connectable to the first interface and the at least one second lance is connectable to the second interface.

41. The device according to claim 40, further comprising at least one valve connected upstream and/or downstream of the overpressure container, compressor, underpressure container, underpressure generator, or a combination thereof.
